(19) United States
(12) Patent Application Publication
(10) Pub. No.: US 2008/0124057 A1
(43) Pub. Date: May 29, 2008

(54) DATA TRANSMITTING METHOD AND APPARATUS FOR SIMULTANEOUSLY REPRODUCING MULTIPLE MOVING PICTURE CONTENTS, AND METHOD AND APPARATUS FOR SIMULTANEOUSLY REPRODUCING MULTIPLE MOVING PICTURE CONTENTS

(75) Inventors: Myoung-soon CHOI, Yongin-si (KR); Hyok-sung Choi, Yongin-si (KR); Seung-hun Jeon, Seoul (KR); Su-hyun Kim, Seoul (KR); Seong-kook Shin, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/837,178

(22) Filed: Aug. 10, 2007

(30) Foreign Application Priority Data
Nov. 27, 2006 (KR) 10-2006-0117914

(51) Int. Cl. H04N 7/26; H04N 7/173

(52) U.S. Cl. 386/124; 725/105

(57) ABSTRACT

A data transmitting method of simultaneously reproducing a plurality of moving picture contents includes: encoding a plurality of moving picture contents into a single moving picture content; and transmitting the encoded moving picture content. The data transmitting method further includes receiving play list information for specifying the plurality of moving pictures contents that are to be simultaneously reproduced before the decoding, wherein, in the encoding, the plurality of moving picture contents specified by the received play list information are encoded into a single moving picture content.

### CROSS-REFERENCE TO RELATED PATENT APPLICATION

This application claims priority from Korean Patent Application No. 10-2006-0117914, filed on Nov. 27, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a data transmitting method and apparatus for simultaneously reproducing a plurality of moving picture contents and a method and apparatus for simultaneously reproducing a plurality of moving picture contents.

2. Description of the Related Art

In general, a user manually changes a channel in order to see what kind of program is being broadcast on other channels while watching a certain television program. However, in such a method, a user needs to repeatedly press a channel button a plurality of times equal to the number of channels viewed during such a channel search operation and cannot simultaneously see different programs that are being broadcast on other channels.

In order to overcome the above shortcomings, a method of outputting a plurality of contents using a picture-in-picture (PIP) screen has been developed. This method is advantageous in that other television programs being broadcast through a variety of different channels can be shown on the PIP screen in addition to the program a user is currently watching. Accordingly, the number of times the channel button needs to be pressed can be relatively reduced, and the program a user is currently watching can also be shown on the screen even during the channel search operation. Typically, most of the moving picture reproducing apparatuses having the PIP function provide only two PIP screens, and even when the apparatus can provide a plurality of PIP screens, moving pictures of remaining channels other than a selected channel are displayed as a still shot because the network traffic amount may significantly increase and a television set may be overloaded when moving picture contents of all channels are simultaneously displayed on a single screen.

As such, in the related art, it is impossible to simultaneously reproduce all moving picture contents currently being broadcast through a variety of channels on a single screen. Therefore, a user needs to frequently press the channel button in order to search the channels, and the contents currently being broadcast through remaining channels other than the selected channel cannot be identified during the channel search operation.

### SUMMARY OF THE INVENTION

The present invention provides a data transmitting method and apparatus for simultaneously reproducing a plurality of moving picture contents and a method and apparatus for simultaneously reproducing a plurality of moving picture contents, by which the above-mentioned shortcomings, in which a user needs to frequently press a channel button in order to search the channels, can be overcome by outputting a plurality of moving picture contents on a single screen, and contents on other channels can be identified even during the channel search operation.

According to an aspect of the present invention, there is provided a data transmitting method for simultaneously reproducing a plurality of moving picture contents, comprising: encoding a plurality of moving picture contents into single moving picture content; and transmitting the encoded moving picture content.

The data transmitting method may further comprise receiving play list information for specifying a plurality of the moving pictures that will be simultaneously reproduced before the encoding, wherein, in the encoding, a plurality of the moving picture contents specified by the received play list information are encoded into the single moving picture content.

In the transmitting of the encoded moving picture content, the encoded moving picture content and metadata including location information representing locations where the plurality of moving picture contents are to be reproduced may be transmitted.

The metadata may include information on at least one of titles, reproducing times, producers, resolutions, and sizes of the plurality of moving picture contents.

The data transmitting method may further comprise: receiving a plurality of encoded moving picture contents from a plurality of broadcasting channels; and decoding the plurality of encoded moving picture contents.

The encoding may include reducing sizes of the plurality of moving picture contents and sequentially arranging the plurality of moving picture contents on the single moving picture content.

The receipt of the play list information may include further receiving at least one of the number of contents that will be simultaneously reproduced and information on resolutions of the plurality of contents.

According to another aspect of the present invention, there is provided a method of simultaneously reproducing a plurality of moving picture contents, comprising: receiving a single moving picture content obtained by encoding a plurality of moving picture contents; decoding the encoded moving picture content; and outputting a plurality of moving picture contents included in the decoded moving picture content by rearranging them on a screen.

The receipt of the single moving picture content may include receiving metadata containing location information representing locations where the plurality of moving picture contents are reproduced, together with the single moving picture content obtained by encoding the plurality of moving picture contents, and the outputting may include rearranging the plurality of moving picture contents on a screen on the basis of the received metadata.

The metadata may include information on at least one of titles, reproducing times, producers, resolutions, and sizes of a plurality of contents.

The method may further include selecting one of a plurality of the contents rearranged and outputting the selected content onto an entire screen.

The outputting may include rearranging and outputting the plurality of contents in a picture-in-picture (PIP) format.

The outputting may include rearranging and outputting the plurality of contents in a thumbnail format.

The outputting may include rearranging and outputting the plurality of contents together with information on at least one of titles, reproducing times, and producers of the plurality of contents on the basis of the metadata.

The content rearranged in a thumbnail format may be output in a size and a resolution different from those of the metadata.

According to another aspect of the present invention, there is provided a data transmitting apparatus for simultaneously reproducing a plurality of moving picture contents, comprising: an encoder unit which encodes a plurality of moving picture contents into single moving picture content; and a transmitter unit which transmits the encoded moving picture content.

The data transmitting apparatus may further include a receiver unit which receives play list information for specifying a plurality of moving picture contents that will be simultaneously reproduced, and the encoder may encode the plurality of moving picture contents specified by the play list information into the single moving picture content.

The data transmitting apparatus may further include a decoder unit which decodes a plurality of the moving picture contents that have been encoded and received, and the receiver unit receives the plurality of encoded moving picture contents through a plurality of broadcasting channels.

The data transmitting apparatus may further comprise a storage unit which stores the plurality of moving picture contents.

According to another aspect of the present invention, there is provided an apparatus for simultaneously reproducing a plurality of moving picture contents, comprising: a receiver unit which receives a single moving picture content obtained by encoding a plurality of moving picture contents; a decoder which decodes the encoded moving picture content; and an output unit which outputs a plurality of the moving picture contents included in the decoded moving picture content by arranging them on a screen.

According to another aspect of the present invention, there is provided a computer-readable medium having embodied thereon a computer program for a data transmitting method for simultaneously reproducing a plurality of moving picture contents.

According to another aspect of the present invention, there is provided a computer-readable medium having embodied thereon a computer program for a method for simultaneously reproducing a plurality of moving picture contents.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a data transmitting apparatus for simultaneously reproducing a plurality of moving picture contents according to an exemplary embodiment of the present invention;

FIG. 2 is a picture diagram for describing a method of encoding a plurality of moving picture contents in a data transmitting apparatus for simultaneously reproducing a plurality of moving picture contents according to an exemplary embodiment of the present invention;

FIG. 3 is a picture diagram for describing location information of metadata according to an exemplary embodiment of the present invention;

FIG. 4 is a flowchart of operations of a data transmitting apparatus for simultaneously reproducing a plurality of moving picture contents according to an exemplary embodiment of the present invention;

FIG. 5 is a block diagram illustrating an apparatus for simultaneously reproducing a plurality of moving picture contents according to an exemplary embodiment of the present invention;

FIG. 6 is a picture diagram illustrating a method of rearranging a plurality of moving picture contents according to an exemplary embodiment of the present invention;

FIG. 7 is a picture diagram illustrating a method of rearranging a plurality of moving picture contents according to another exemplary embodiment of the present invention;

FIG. 8 is a flowchart of a method of simultaneously reproducing a plurality of moving picture contents according to an exemplary embodiment of the present invention;

FIG. 9 is a schematic diagram for describing operations of a method of simultaneously reproducing moving picture contents and a data transmitting method according to an exemplary embodiment of the present invention; and

FIG. 10 is a schematic diagram for describing operations of a method of simultaneously reproducing moving picture contents and a data transmitting method according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

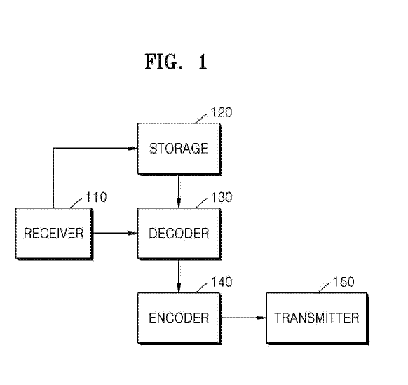

FIG. 1 is a block diagram illustrating a data transmitting apparatus for simultaneously reproducing a plurality of moving picture contents according to an exemplary embodiment of the present invention.

The data transmitting apparatus for simultaneously reproducing a plurality of moving picture contents according to an exemplary embodiment of the present invention includes a receiver unit 110, a storage unit 120, a decoder unit 130, an encoder unit 140, and a transmitter unit 150.

The receiver unit 110 receives encoded moving picture contents through a plurality of broadcast channels and programming play list information for specifying a plurality of moving picture contents that will be simultaneously reproduced.

For example, even if the receiver 110 receives different moving picture contents through twenty broadcast channels, the play list information of the moving picture contents that can be simultaneously reproduced may only contain broadcast channels 1 to 9.

In this case, a user may transmit the receiver 110 information on the number of the moving picture contents and resolutions of each moving picture that will be simultaneously reproduced. That is, in the above example, the receiver unit 110 may receive information notifying that nine contents are simultaneously reproduced with a resolution of 320×240 pixels.

In addition, the moving picture contents that will be simultaneously reproduced may include different types of moving picture contents, such as movies stored in the storage unit 120 of the data transmitting apparatus, as will be described below, as well as those received from the broadcast channels.

The storage unit 120 stores a plurality of moving picture contents.

The storage unit 120 may store the moving picture contents of broadcast channels broadcasted in real-time from the receiver unit 110 and may store the moving picture contents of broadcast channels that have been previously received. In addition, the moving picture contents may be received using other routes and then stored. For example, a user may buy movies from a film producer or a film provider and store them in the storage unit 120.

The decoder unit 130 decodes a plurality of the received moving picture contents that have been encoded.

In this case, the decoder 130 may receive a plurality of moving picture contents from the receiver unit 110 or the storage unit 120. When the moving picture contents are received from the receiver unit 110, they are received through the broadcast channel in real-time and then directly decoded.

The encoder unit 140 encodes a plurality of moving picture contents specified in the received play list information into a single moving picture content.

For example, when the play list information includes moving picture contents of channels 1 to 9, only the moving picture contents of the channels 1 to 9 out of 12 moving picture contents are encoded into the single moving picture content.

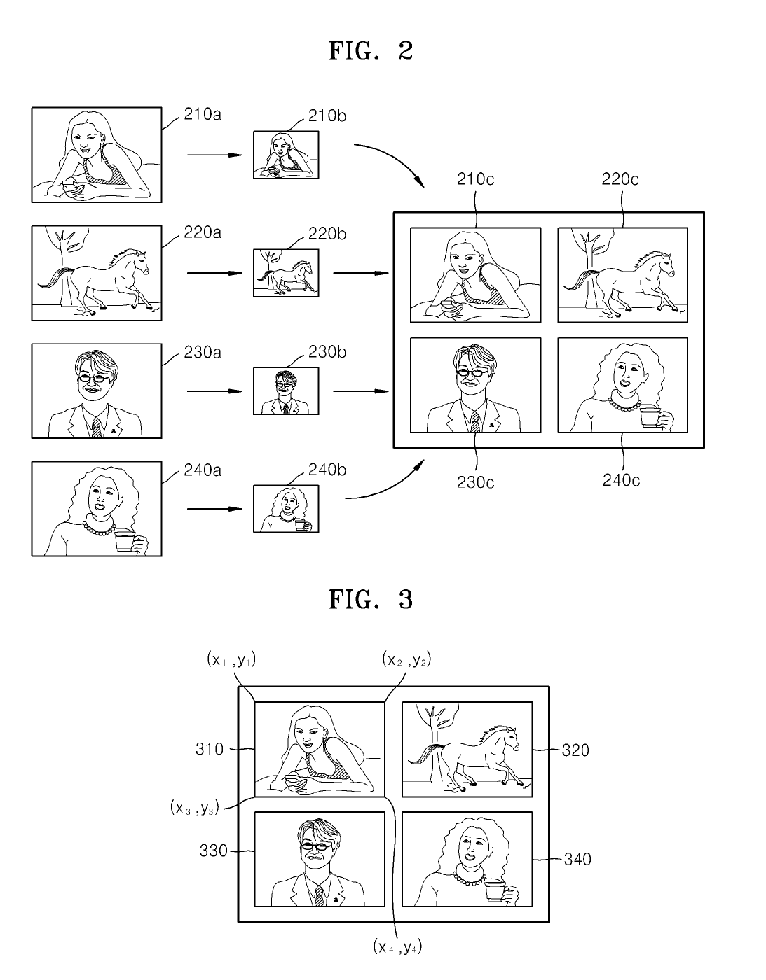

FIG. 2 is a picture diagram for describing a method of encoding a plurality of moving picture contents in a data transmitting apparatus for simultaneously reproducing a plurality of moving picture contents according to an exemplary embodiment of the present invention.

Referring to FIG. 2, firstly, the moving picture contents 210a, 220a, 230a, and 240a are converted into moving picture contents 210b, 220b, 230b, and 240b, respectively, having reduced sizes. The reduced moving picture contents 210b, 220b, 230b, and 240b are arranged on a single screen in an appropriate order, such as a top-down order of 210c, 220c, 230c, and 240c and encoded into the single moving picture content. Such an arrangement may be modified according to each implementation.

The transmitter unit 150 transmits the encoded moving picture content and metadata including location information representing locations where a plurality of moving picture contents will be reproduced. In this case, the metadata may further include information on titles, reproducing times, producers, resolutions, and sizes of the plurality of contents.

Although the transmitter unit 150 transmits the metadata together with the encoded moving picture content in the aforementioned description, only the moving picture content can be transmitted without the metadata. In addition, the reproducing apparatus, which receives the metadata together with the encoded moving picture content, does not necessarily rearrange and output a plurality of the moving picture contents on the basis of the location information included in the metadata. Instead, the moving picture contents may be rearranged and output in various formats based on a specification set for the reproducing apparatus.

Furthermore, even when the reproducing apparatus can support various output formats, the reproducing apparatus may be instructed to necessarily rearrange and output the moving picture contents based on the metadata transmitted from the transmitter unit 150.

FIG. 3 is a picture diagram for describing location information of metadata according to an exemplary embodiment of the present invention.

Referring to FIG. 3, the location of the moving picture content 310 displayed on the upper left side is specified by four coordinates values , , , and . The metadata includes coordinate information capable of specifying each location of the moving picture contents 310, 320, 330, and 340. In this case, when the location can be simply specified using the coordinate values of two end points of a diagonal line, such as and , the metadata may include only two coordinate values for each moving picture content.

The location information of the moving picture contents is not limited to the aforementioned coordinate format, but may have various formats capable of specifying the locations of the moving picture contents.

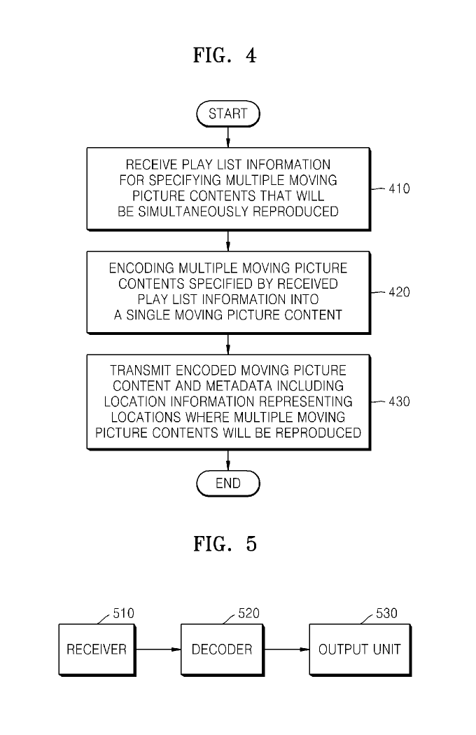

FIG. 4 is a flowchart of operations of a data transmitting apparatus for simultaneously reproducing a plurality of moving picture contents according to an exemplary embodiment of the present invention.

In operation 410, play list information for specifying a plurality of moving picture contents that will be simultaneously reproduced is received.

As described above, information on the number of contents that will be simultaneously reproduced and the resolutions of the contents can be received together.

In operation 420, a plurality of moving picture contents specified by the received play list information are encoded in a single moving picture content.

In this case, as described above, a plurality of the moving picture contents encoded into the single moving picture content may be those received from a broadcast center or those stored in the storage unit 120.

In operation 430, the encoded moving picture contents and the metadata including location information representing the locations where a plurality of the moving picture contents will be reproduced are transmitted.

In this case, the metadata may include information on titles, reproducing times, and producers of the moving picture contents that will be simultaneously reproduced.

A configuration and operations of the apparatus for simultaneously reproducing a plurality of moving picture contents will now be described.

FIG. 5 is a block diagram illustrating an apparatus for simultaneously reproducing a plurality of moving picture contents according to an exemplary embodiment of the present invention.

Referring to FIG. 5, the apparatus for simultaneously reproducing a plurality of moving picture contents according to an exemplary embodiment of the present invention includes a receiver unit 510, a decoder unit 520, and an output unit 530.

The receiver unit 510 receives encoded moving picture contents through a plurality of broadcast channels. The receiver unit 510 also receives a single moving picture content encoded from a plurality of the moving picture contents and metadata including location information indicating the locations where a plurality of moving picture contents will be reproduced.

As described above, the receiver unit 510 may receive only the single moving picture content encoded from the plurality of moving picture contents without the metadata.

The receiver unit 510 receives a plurality of moving picture contents through the broadcast channels on analog or digital signals and receives the single moving picture content encoded from the plurality of moving picture contents on digital signals. In this case, when the digital signals are received, the moving picture content may be received in the form of Internet Protocol (IP) packets.

The receiver unit 510 may receive various kinds of codecs for reproducing the received moving picture contents.

When the output unit 530, which will be described later, is to reproduce the moving pictures on an entire screen, one of a plurality of moving picture contents received on analog or digital signals is selected and then reproduced on an entire screen.

In this case, when the broadcast channel includes a server which functions as an apparatus for simultaneously reproducing a plurality of moving picture contents, each broadcast channel transmits both analog and digital signals.

The decoder 520 decodes the moving picture contents that have been encoded.

In this case, in the related art, the decoding should be performed a plurality of times as the broadcasting signals are received through the plurality of broadcast channels. On the contrary, according to an exemplary embodiment of the present invention, since the single moving picture content obtained by encoding the plurality of moving picture contents is received, the decoding can be performed only once. For this reason, the apparatus for simultaneously reproducing a plurality of moving picture contents according to an exemplary embodiment of the present invention can rearrange and output a plurality of moving picture contents included in the received single moving picture content without overloading a system.

The output unit 530 rearranges and outputs the plurality of moving picture contents included in the decoded moving picture content onto a screen on the basis of the received metadata.

In this case, the output unit 530 identifies each location of the plurality of moving picture contents on the basis of the location information of the metadata, and rearranges and outputs the plurality of moving picture contents with new coordinate values. Furthermore, the moving picture contents are reproduced on a screen, not in a still shot format, but in a moving picture format. This rearrangement follows a format set for the apparatus for simultaneously reproducing the plurality of moving picture contents.

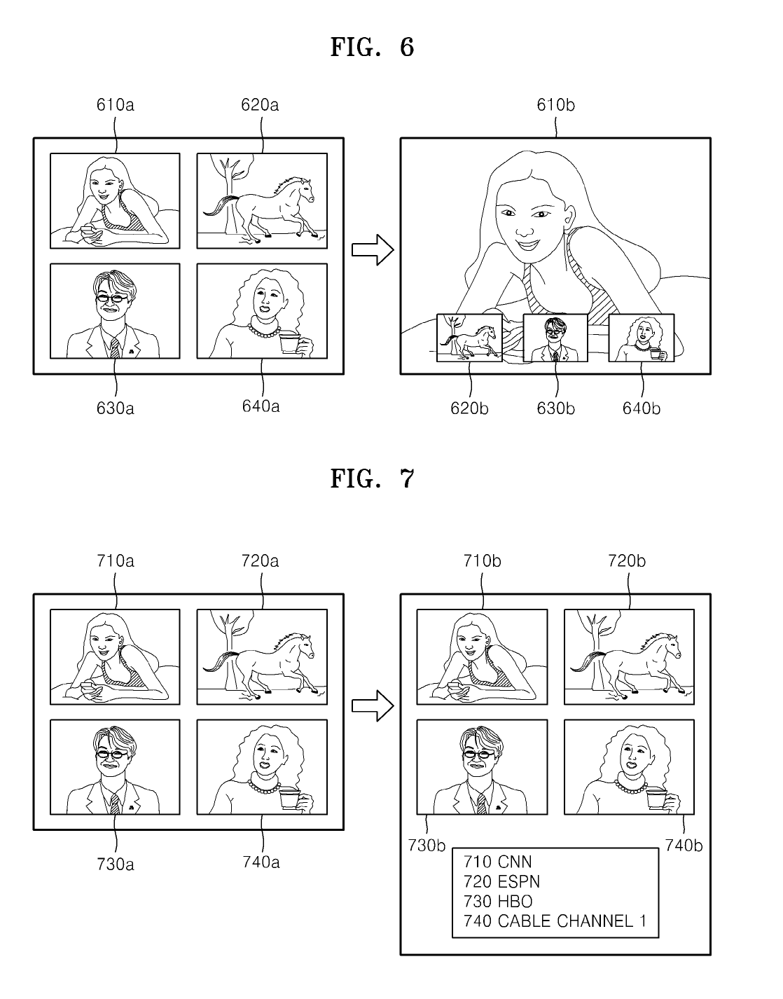

For example, one of the formats shown in FIGS. 6 and 7 may be selected by a user or a format set in a specification of the apparatus may be used to output the moving picture contents. That is, when a single apparatus supports various kinds of output screen formats, a user may select one of them, and the moving picture contents may be rearranged and output according to the selected format. On the contrary, when a single apparatus supports a single output screen format, the received moving picture contents may be rearranged and output according to a format specified for that apparatus.

FIG. 6 is a picture diagram illustrating a method of rearranging a plurality of moving picture contents according to an exemplary embodiment of the present invention.

In FIG. 6, a plurality of moving picture contents are rearranged and output in a picture-in-picture (PIP) format. Referring to FIG. 6, a single moving picture content 610b selected from four moving picture contents 610a, 620a, 630a, and 640a shown in the drawing on the left is displayed on an entire screen, while the remaining moving picture contents 620b, 630b, and 640b are displayed in three reduced windows.

FIG. 7 is a picture diagram illustrating a method of rearranging a plurality of moving picture contents according to another exemplary embodiment of the present invention.

In FIG. 7, a plurality of moving picture contents are rearranged and output in thumbnail format. Referring FIG. 7, four moving picture contents 710a, 720a, 730a, and 740a shown in the left drawing are rearranged and output in thumbnail format in the drawing on the right. In addition, information on each moving picture content is displayed under the moving picture contents 710b, 720b, 730b, and 740b output in thumbnail format. Such information may include information on titles, reproducing times, producers, and characters of the moving picture contents.

In FIGS. 6 and 7, when single moving picture content is selected from four moving picture contents displayed on a screen, the selected moving picture content may be displayed on an entire screen. In this case, whether or not remaining moving picture contents that are not selected should be displayed on a screen can be determined by a user. That is, if a user wants the remaining moving picture contents to be displayed on a screen, small windows containing the remaining moving picture contents may be overlappingly displayed on a screen where the selected moving picture content is already displayed over its entire area. Otherwise, only the selected moving picture content may be displayed on an entire screen.

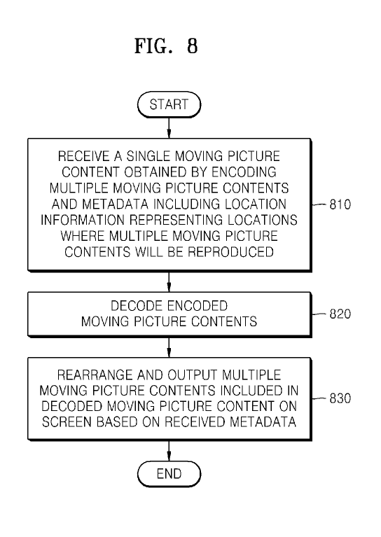

FIG. 8 is a flowchart of a method of simultaneously reproducing a plurality of moving picture contents according to an exemplary embodiment of the present invention.

In operation 810, single moving picture content obtained by encoding a plurality of moving picture contents and metadata including location information representing locations where a plurality of the moving picture contents will be displayed are received.

In this case, as described above, only single moving picture content obtained by encoding the plurality of moving picture contents may be received without the metadata.

In operation 820, the moving picture contents that have been encoded are decoded.

In operation 830, a plurality of the decoded moving picture contents are rearranged and output onto a screen on the basis of the received metadata.

As described above, when one of the moving picture contents output onto a screen is selected, the selected moving picture is displayed on an entire screen.

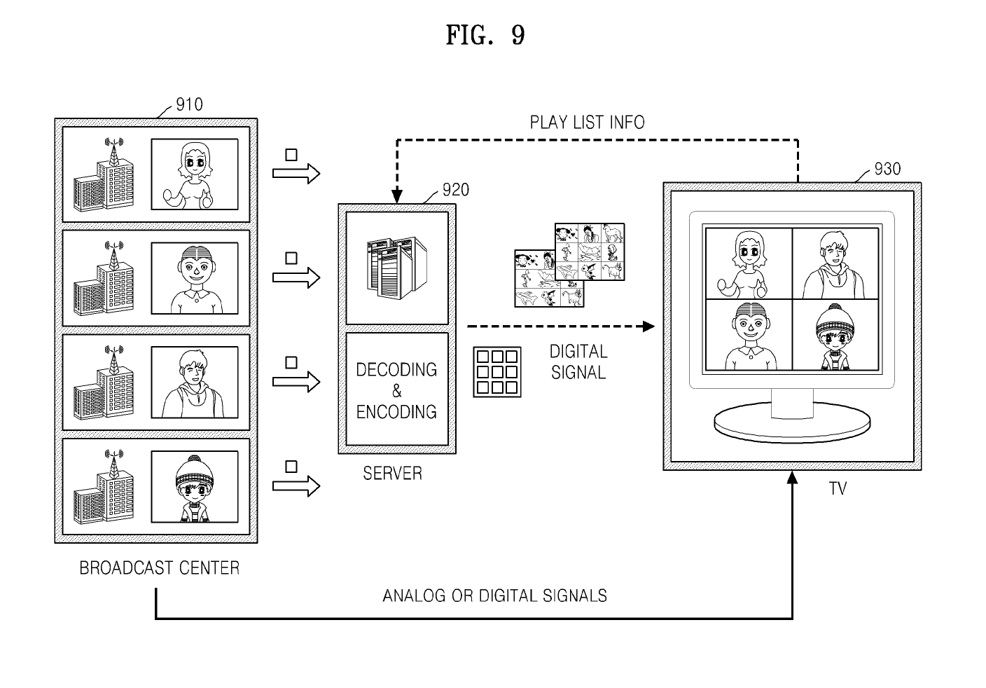

FIG. 9 is a schematic diagram for describing operations of a method of simultaneously reproducing moving picture contents and a data transmitting method according to an exemplary embodiment of the present invention.

Referring to FIG. 9, a television set 930 transmits to a server 920 play list information for specifying a plurality of moving picture contents that will be simultaneously reproduced. The server 920 encodes a plurality of moving picture contents specified by the received play list information into a single moving picture content and transmits the encoded moving picture content to the television set 930. For example, the server 920 may decode the moving picture contents received from several broadcast centers 910 such as CNN, HBO, ABC, or ESPN, encodes them into single moving picture content, and transmits the single moving picture content to the television set 930 again.

The television set 930 decodes the received moving picture content and rearranges the locations of a plurality of the moving picture contents included in the encoded single moving picture content. Then, the rearranged moving picture contents are displayed on a screen.

In this case, the television set 930 may further receive the metadata including the location information together with the moving picture content, as described above.

When one of the moving picture contents output on a screen is selected, the selected moving picture content is displayed on an entire screen. In this case, the moving picture contents received from the broadcast center 910 in analog or digital signal format may be displayed on an entire screen. Otherwise, the moving picture contents received from the sever 920 in digital signal format may be displayed on an entire screen.

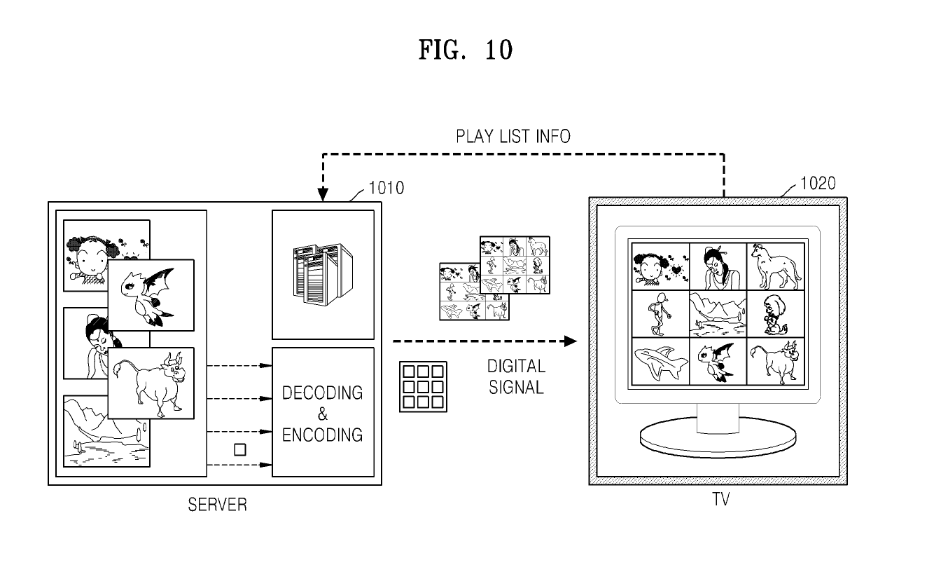

FIG. 10 is a schematic diagram for describing operations of a method of simultaneously reproducing moving picture contents and a data transmitting method according to another exemplary embodiment of the present invention.

Referring to FIG. 10, a television set 1020 transmits to a server 1010 play list information for specifying a plurality of moving picture contents that will be simultaneously reproduced.

The server 1010 decodes moving picture contents stored in the server 1010 itself and encodes them into a single moving picture content. Then, the encoded single moving picture content is transmitted to the television set 1020.

The television set 1020 decodes the received moving picture content and rearranges each location of the moving picture contents included in the single moving picture content, so that the rearranged moving picture contents are displayed on a screen.

As described above, the television set 1020 may receive metadata including location information together with the moving picture content.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to the exemplary embodiments of the present invention, it is possible to remove the above-mentioned shortcomings, whereby a user needs to frequently press a channel button in order to search the channels, by outputting a plurality of moving picture contents onto a single screen, and identify contents on other channels even during the channel search operation. In addition, each moving picture content can be displayed in each desired location, and they can be displayed in various layout formats.

While the present invention has been particularly shown and described with reference to exemplary embodiments thereof, it will be understood by those skilled in the art that various changes in form and details may be made therein without departing from the spirit and scope of the present invention as defined by the appended claims. The exemplary embodiments should be considered in descriptive sense only and not for purposes of limitation. Therefore, the scope of the invention is defined not by the detailed description of the present invention but by the appended claims, and all differences within the scope will be construed as being included in the present invention.

What is claimed is:

1. A data transmitting method for simultaneously reproducing a plurality of moving picture contents, the data transmitting method comprising:
encoding a plurality of moving picture contents into a single moving picture content; and
transmitting the encoded moving picture content.

2. The data transmitting method of claim 1, further comprising receiving play list information for specifying a plurality of the moving pictures that will be simultaneously reproduced before the encoding,
wherein, in the encoding, the plurality of the moving picture contents specified by the received play list information are encoded into the single moving picture content.

3. The data transmitting method of claim 1, wherein, in the transmitting of the encoded moving picture content, the encoded moving picture content and metadata including location information representing locations where the plurality of moving picture contents are to be reproduced are transmitted.

4. The data transmitting method of claim 3, wherein the metadata further includes information on at least one of titles, reproducing times, producers, resolutions, and sizes of the plurality of moving picture contents.

5. The data transmitting method of claim 1, further comprising:
receiving a plurality of encoded moving picture contents from a plurality of broadcast channels; and
decoding the plurality of encoded moving picture contents.

6. The data transmitting method of claim 1, wherein the encoding includes reducing sizes of the plurality of moving picture contents and sequentially arranging the plurality of moving picture contents on the single moving picture content.

7. The data transmitting method of claim 2, wherein the receiving of the play list information includes further receiving at least one of a number of contents that will be simultaneously reproduced and information on resolutions of the plurality of the contents.

8. A method of simultaneously reproducing a plurality of moving picture contents, the method comprising:
receiving a single moving picture content obtained by encoding a plurality of moving picture contents;
decoding the encoded moving picture content; and
outputting the plurality of moving picture contents included in the decoded moving picture content by rearranging the plurality of contents on a screen.

9. The method of claim 8,
wherein the receiving of the single moving picture content includes receiving metadata containing location information representing locations where the plurality of moving picture contents are reproduced, together with the single moving picture content obtained by encoding the plurality of moving picture contents, and
wherein the outputting includes rearranging the plurality of moving picture contents on a screen based on the received metadata.

10. The method of claim 9, wherein the metadata includes information on at least one of titles, reproducing times, producers, resolutions, and sizes of the plurality of contents.

11. The method of claim 8, further including selecting one of the rearranged plurality of contents and outputting the selected content onto an entire screen.

12. The method of claim 8, wherein the outputting includes rearranging and outputting the plurality of contents in a picture-in-picture format.

13. The method of claim 8, wherein the outputting includes rearranging and outputting the plurality of contents in a thumbnail format.

14. The method of claim 9, wherein the outputting includes rearranging and outputting the plurality of contents together with information on at least one of titles, reproducing times, and producers of the plurality of contents based on the metadata.

15. The method of claim 13, wherein the content rearranged in thumbnail format is output in a size and a resolution different from a size and a resolution of the metadata.

16. A data transmitting apparatus for simultaneously reproducing a plurality of moving picture contents, the data transmitting apparatus comprising:
an encoder unit which encodes a plurality of moving picture contents into a single moving picture content; and
a transmitter unit which transmits the encoded moving picture content.

17. The data transmitting apparatus of claim 16, further including a receiver unit which receives play list information for specifying a plurality of moving picture contents that will be simultaneously reproduced,
wherein the encoder encodes the plurality of moving picture contents specified by the play list information into the single moving picture content.

18. The data transmitting apparatus of claim 16, wherein the transmitter unit transmits the encoded moving picture content and metadata including location information representing locations where the plurality of moving picture contents will be reproduced.

19. The data transmitting apparatus of claim 16, wherein the metadata further includes information on at least one of titles, reproducing times, and producers of the plurality of contents.

20. The data transmitting apparatus of claim 16, further including a decoder unit which decodes the plurality of moving picture contents that have been encoded and received,
wherein the receiver unit receives the plurality of the encoded moving picture contents through a plurality of broadcast channels.

21. The data transmitting apparatus of claim 16, wherein the encoder reduces a size of each moving picture of the plurality of contents and sequentially arranges the moving pictures in the single moving picture content.

22. The data transmitting apparatus of claim 16, further comprising a storage unit which stores the plurality of moving picture contents.

23. The data transmitting apparatus of claim 17, wherein the receiver unit further receives information on at least one of a number of contents that are to be simultaneously reproduced and resolutions of the plurality of contents.

24. An apparatus for simultaneously reproducing a plurality of moving picture contents, the apparatus comprising:
a receiver unit which receives a single moving picture content obtained by encoding a plurality of moving picture contents;
a decoder which decodes the encoded moving picture content; and
an output unit which outputs the plurality of the moving picture contents included in the decoded moving picture content by arranging the plurality of contents on a screen.

25. The apparatus of claim 24,
wherein the receiver unit receives the single moving picture content obtained by encoding the plurality of moving picture contents and metadata including location information representing locations where the plurality of moving picture contents are to be reproduced, and
wherein the output unit outputs the plurality of moving picture contents by arranging the plurality of contents on a screen on the basis of the received metadata.

26. The apparatus of claim 24, wherein the metadata further includes information on at least one of titles, reproducing times, producers, resolutions, and sizes of the plurality of moving picture contents.

27. The apparatus of claim 24, wherein a user selects one of the plurality of contents that have been rearranged and output onto a screen, and the output units outputs the selected content onto an entire screen.

28. The apparatus of claim 24, wherein the output unit outputs the plurality of contents by arranging them in a picture-in-picture format.

29. The apparatus of claim 24, wherein the output unit outputs the plurality of contents by arranging the plurality of contents in a thumbnail format.

30. The apparatus of claim 25, wherein the output unit outputs the plurality of contents together with information on at least one of titles, reproducing times, and producers of the plurality of contents based on the metadata.

31. The apparatus of claim 29, wherein the output unit outputs the contents rearranged in thumbnail format in a size and a resolution different from a size and a resolution of the metadata.

32. A computer-readable medium having embodied thereon a computer program for executing a data transmitting method for simultaneously reproducing a plurality of moving picture contents, the data transmitting method comprising:
encoding a plurality of moving picture contents into a single moving picture content; and
transmitting the encoded moving picture content.

33. A computer-readable medium having embodied thereon a computer program for executing a method of simultaneously reproducing a plurality of moving picture contents, the method comprising:
receiving a single moving picture content obtained by encoding a plurality of moving picture contents;
decoding the encoded moving picture content; and
outputting the plurality of moving picture contents included in the decoded moving picture content by rearranging the plurality of contents on a screen.
